(19) United States
(12) Patent Application Publication
(10) Pub. No.: US 2015/0044069 A1
(43) Pub. Date: Feb. 12, 2015

(54) MECHANICAL COMBUSTION-ENGINE-DRIVEN FLUID PUMP

(71) Applicants: Raffaele Squarcini, Livorno (IT); Elisa Bartalesi, S. Gimignano (SI) (IT); Giacomo Armenio, Livorno (IT); Paola Forte, Pisa (IT); Francesco Frendo, Viareggio-Lucca (IT); Rocco Rizzo, Pisa (IT); Francesco Bucchi, Cascina-Pisa (IT); Andrea Ferri, Roncocesi (RE) (IT)

(72) Inventors: Raffaele Squarcini, Livorno (IT); Elisa Bartalesi, S. Gimignano (SI) (IT); Giacomo Armenio, Livorno (IT); Paola Forte, Pisa (IT); Francesco Frendo, Viareggio-Lucca (IT); Rocco Rizzo, Pisa (IT); Francesco Bucchi, Cascina-Pisa (IT); Andrea Ferri, Roncocesi (RE) (IT)

(73) Assignee: PIERBURG PUMP TECHNOLOGY ITALY S.P.A., LANCIANO (IT)

(21) Appl. No.: 14/130,678

(22) PCT Filed: Jan. 24, 2012
(86) PCT No.: PCT/EP2012/051006

§ 371 Date: Apr. 2, 2014

(30) Foreign Application Priority Data
Jul. 4, 2011 (EP) 11425176.2

(51) Int. Cl. F16D 37/02; F04D 25/02

(52) U.S. Cl. CPC F16D 37/02; F04D 25/02
USPC 417/223

(57) ABSTRACT

A mechanical fluid pump driven by a combustion engine includes an input shaft which is directly driven by the combustion engine, a pumping unit comprising a pump rotor, and a clutch arranged between the input shaft and the pump rotor. The clutch is provided as a magneto-rheological clutch comprising two clutch bodies, a fluid gap arranged between the two clutch bodies, the fluid gap being filled with a magneto-rheological fluid, and a permanent magnet element which is shiftable between an engaged position where a magnetic field penetration flux of the permanent magnet element penetrates the fluid gap with a high magnetic flux, and a disengaged position where the magnetic field penetration flux of the permanent magnet element is less than in the engaged position. An actuator is configured to move the permanent magnet element between the engaged position and the disengaged position.

### CROSS REFERENCE TO PRIOR APPLICATIONS

This application is a U.S. National Phase application under 35 U.S.C. §371 of International Application No. PCT/EP2012/051006, filed on Jan. 24, 2012 and which claims benefit to European Patent Application No. 11425176.2, filed on Jul. 4, 2011. The International Application was published in English on Jan. 10, 2013 as WO 2013/004401 A1 under PCT Article 21(2).

### FIELD

The present invention relates to a mechanical combustion-engine-driven fluid pump which is driven by an internal combustion engine and which provides a liquid, a pressurized gas or a vacuum to an automotive unit.

### BACKGROUND

The fluid pump can be a lubricant pump, a coolant pump, a vacuum pump, or a pump providing a pressurized gas, for example, pressurized air. The mechanical fluid pump is not to driven by an electrical rotor but is directly coupled to the combustion engine. The rotational speed of the fluid pump is therefore proportional to the rotational speed of the combustion engine so that the fluid pump always rotates even if no need for a fluid supply or for a suction activity to create a vacuum exists.

U.S. Pat. No. 7,422,093 B2 describes a fluid pump for providing a pressurized liquid for hydraulic power steering. The fluid pump is provided with a magneto-rheological clutch so that the pump performance can be controlled depending on the fluid demand and the pressure demand of the power steering. The magnetic field for increasing the viscosity of the magneto-rheological fluid is provided by an electromagnetic coil. If the electromagnetic coil fails, the magneto-rheological clutch cannot be engaged, so that the fluid pump does not work. This risk of failure is not acceptable for vital fluid pumps, such as a lubricant pump, a coolant pump, or a vacuum pump for a brake assistance system.

### SUMMARY

An aspect of the present invention is to provide a failsafe mechanical combustion-engine-driven fluid pump with a magneto-rheological clutch.

In an embodiment, the present invention provides [A mechanical fluid pump configured to be driven by a combustion engine which includes an input shaft which is configured to be directly driven by the combustion engine, a pumping unit comprising a pump rotor, and a clutch arranged between the input shaft and the pump rotor. The clutch is provided as a magneto-rheological clutch comprising two clutch bodies, a fluid gap arranged between the two clutch bodies, the fluid gap being filled with a magneto-rheological fluid, and a permanent magnet element which is configured to be shiftable between an engaged position where a magnetic field penetration flux of the permanent magnet element penetrates the fluid gap with a high magnetic flux, and a disengaged position where the magnetic field penetration flux of the permanent magnet element is less than in the engaged position. An actuator is configured to move the permanent magnet element between the engaged position and the disengaged position.

### BRIEF DESCRIPTION OF THE DRAWINGS

The present invention is described in greater detail below on the basis of embodiments and of the drawings in which:

FIG. 1 shows a mechanical combustion-engine-driven fluid pump in a longitudinal cross-section in the engaged state; and

FIG. 2 shows the fluid pump of FIG. 1 in the disengaged state.

### DETAILED DESCRIPTION

The fluid pump according to the present invention is provided with an input shaft which is directly driven by the combustion engine and with a pumping unit with a pump rotor for pumping the fluid which is a liquid or a gas. The term “directly driven” means that no clutch exists between the rotational element of the engine and the input shaft of the pump. The input shaft of the pump can be driven by the engine via a belt, gear wheels, or by a direct coupling with the camshaft or the crankshaft of the engine. The magneto-rheological clutch is provided between the input shaft and the pump rotor and comprises a fluid gap between two clutch bodies. One clutch body is directly connected to the input shaft and the other clutch body is directly connected to the pump rotor. The fluid gap between the two clutch bodies is filled with a magneto-rheological fluid.

The magnetic field for increasing the viscosity of the magneto-rheological fluid is not generated by an electromagnetic means, but is generated by a permanent magnet element which is shiftable between a disengaged position in which the magnet element's magnetic field penetration flux in the gap is low, and an engaged position in which the magnetic field flux penetration in the gap is high. In the engaged position, the permanent magnet is close to the gap, and in the disengaged position, the permanent magnet is more distant from the gap. The magnet element is moved between the engaged and the disengaged position by a separate magnet element actuator.

Since the magnetic field for penetrating the gap and the magneto-rheological fluid in the gap is not generated by an electromagnet, the magneto-rheological clutch can generally also be engaged if the electric control of the pump fails.

In an embodiment of the present invention, the permanent magnet element can, for example, be pretensioned by a passive pretension element into its engaged position. If the actuator fails, the pretension element pushes the permanent magnet element into the engaged position. This arrangement makes the clutch concept failsafe. The passive pretension element can, for example, be a spring or another permanent magnet. The passive pretension element does not, however, need any external energy to provide the pretension force.

In an embodiment of the present invention, the clutch bodies can, for example, be cup-shaped and form a cup-shaped gap between them. The permanent magnet is in its engaged position positioned inside the ring-like shaped cavity defined by the cup-shaped gap. Since the gap between the two clutch bodies is not only disk-shaped, but also comprises a cylindrical portion, the total gap surface area is significantly increased to transmit high torque values without increasing the total diameter of the clutch.

In an embodiment of the present invention, the actuator can, for example, be provided as a vacuum actuator. The vacuum actuator is magnetically neutral and does not generate a electromagnetic field which could penetrate the clutch gap filled with the magneto-rheological fluid.

In an embodiment of the present invention, the actuator can alternatively be an electromagnetic actuator which is provided as an electromagnetic coil. If the electromagnetic actuator is activated, the shiftable permanent magnet element is pulled or pushed into its disengaged position, i.e., distant from the clutch gap. The permanent magnet element can, for example, be magnetized in an axial direction and be axially shiftable.

An embodiment of the present invention is described below under reference to the drawings.

The drawings show a typical automotive arrangement consisting of an internal combustion engine 12, a mechanical fluid/vacuum pump 10 directly driven by the combustion engine 12, and a vacuum-driven/pneumatic brake assistance unit 14. The pump 10 is designed as a vacuum pump and provides low pressure to the brake assistance unit 14.

The combustion engine 12 is mechanically directly connected to an input shaft 20 of a clutch 16 of the pump 10 so that the input shaft 20 always rotates with a rotational speed which is directly proportional to the rotational speed of the internal combustion engine 12.

The clutch 16 is arranged between the input shaft 20 and an output shaft 21 and is a magneto-rheological clutch 16. The clutch 16 connects the input shaft 20 with the output shaft 21 in the engaged clutch state, and disconnects the output shaft 21 from the input shaft 20 in the disengaged state. The clutch 16 is provided with two clutch bodies 22,24 defining a cup-shaped fluid gap 26 therebetween filled with a magneto-rheological fluid 28, an axially-shiftable permanent magnet element 30, a pretension element 44 designed as a spring, and an electromagnetic actuator 42 designed as an electromagnetic ring coil 43.

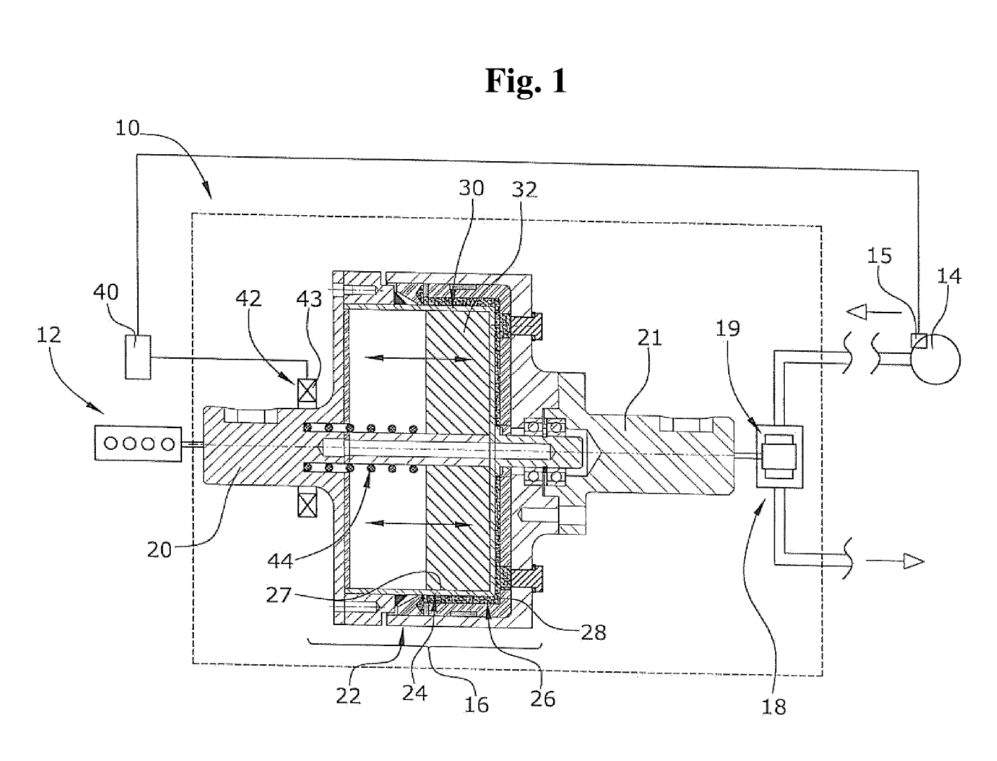

The clutch bodies 22,24 are both cup-shaped so that they define a small cup-shaped fluid gap 26 between them which has a disk-ring-shaped portion and a cylindrical portion. The permanent magnet element 30 is defined as a circular magnet ring body 32 which is axially shiftable and co-rotates with the input-shaft-sided clutch body 24. The magnet ring body 32 is positioned inside of a cup-shaped cavity 27 defined by the cup-shaped fluid gap 26 in the engaged position of the permanent magnet element 30 which is shown in FIG. 1. In this engaged position, the permanent magnet body 32 is close to both portions of the cup-shaped fluid gap 26 containing the magneto-rheological fluid 28 therein so that the magnetic field generated by the permanent magnet element 30 penetrates the magneto-rheological fluid 28 inside the cup-shaped fluid gap 26 with a maximum magnetic flux.

The permanent magnet element 30 is pretensioned by the pretension element 44 into its engaged position as shown in FIG. 1. This arrangement makes the clutch 16 failsafe because the permanent magnet element 30 is always pushed into its engaged position if the actuator 42 should fail. The actuator 42 is, in the present embodiment, an electromagnetic ring coil 43 which axially attracts the permanent magnet element 30 if the electromagnetic ring coil 43 is electrically activated.

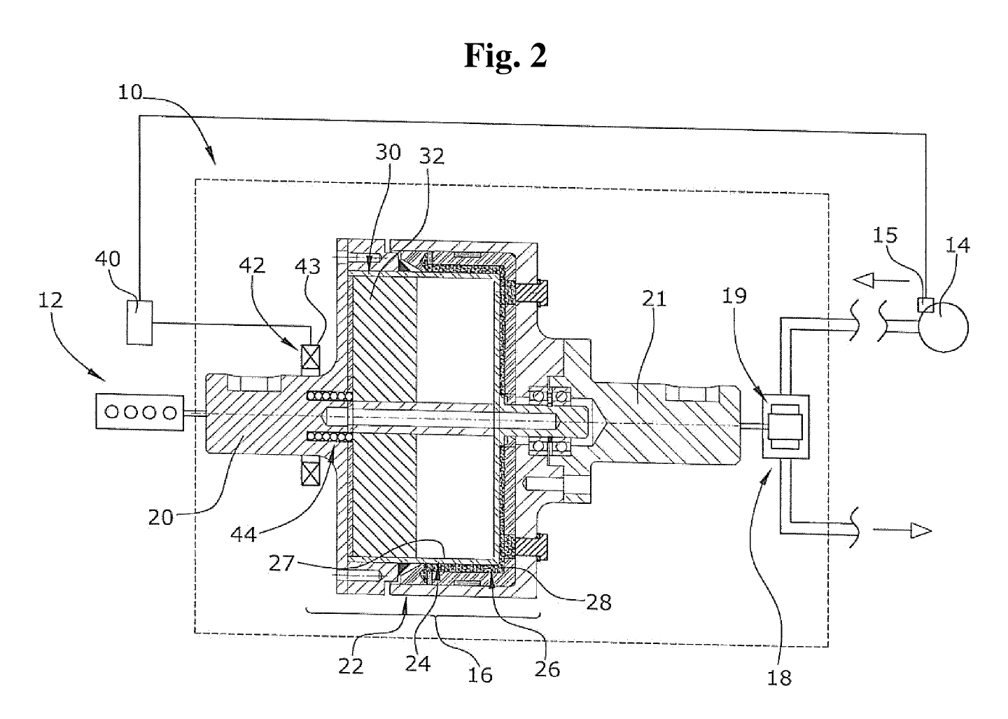

The actuator 42 is controlled by a control unit 40 which is also connected to a pressure sensor 15 of the brake assistance unit 14 via a signal line. The control unit 40 engages and disengages the clutch 16 dependent on the pneumatic pressure in the working chamber of the brake assistance unit 14. As long as the pneumatic pressure in the working chamber of the brake assistance unit 14 is below a critical value, the clutch 16 remains disengaged by continuously energizing the electromagnetic actuator 42 so that the permanent magnet element 30 is pulled into and held in its disengaged position, as shown in FIG. 2. In the disengaged position of the permanent magnet element 30, the magnetic field penetrating the cup-shaped fluid gap 26 has a relatively low flux so that the viscosity of the magneto-rheological fluid is relatively low. As a consequence, the clutch slip is high so that the clutch 16 is more or less disengaged.

As soon as the pneumatic pressure in the working chamber of the brake assistance unit 14 exceeds a critical pressure value, the clutch 16 is switched into the engaged state by not energizing the actuator 42 so that the permanent magnet element 30 is pushed into its engaged position by the pretension element 44, as shown in FIG. 1. In this state the magnetic field flux penetrating the cup-shaped fluid gap 26 is relatively strong so that the viscosity of the magneto-rheological fluid 28 is relatively high. As a consequence, the clutch slip is low so that the clutch 16 is more or less engaged. In this engaged state, the output shaft 21 rotates with the same rotational speed as the input shaft 20. The output shaft 21 drives the pump rotor 19 of the pumping unit 18 so that the working chamber of the brake assistance unit 14 is evacuated until the pneumatic pressure in the working chamber falls below the critical pressure value.

The present invention is not limited to embodiments described herein; reference should be had to the appended claims.

What is claimed is:

1-6. (canceled)

7. A mechanical fluid pump configured to be driven by a combustion engine, the mechanical fluid pump comprising:
an input shaft which is configured to be directly driven by the combustion engine;
a pumping unit comprising a pump rotor; and
a clutch arranged between the input shaft and the pump rotor, the clutch being provided as a magneto-rheological clutch comprising:
two clutch bodies,
a fluid gap arranged between the two clutch bodies, the fluid gap being filled with a magneto-rheological fluid,
a permanent magnet element which is configured to be shiftable between an engaged position where a magnetic field penetration flux of the permanent magnet element penetrates the fluid gap with a high magnetic flux, and a disengaged position where the magnetic field penetration flux of the permanent magnet element is less than in the engaged position, and
an actuator which is configured to move the permanent magnet element between the engaged position and the disengaged position.

8. The mechanical fluid pump as recited in claim 7, wherein the permanent magnet element is configured to be shiftable in an axial direction.

9. The mechanical fluid pump as recited in claim 7, wherein the clutch bodies are configured to be cup-shaped so as to form a cup-shaped gap therebetween, the cup-shaped gap defining a cup-shaped cavity, and the permanent magnet element, in the engaged position, is positioned inside the cup-shaped cavity.

10. The mechanical fluid pump as recited in claim 7, further comprising a passive pretension element which is configured to pretension the permanent magnet element into the engaged position.

11. The mechanical fluid pump as recited in claim 7, wherein the actuator is an electromagnetic actuator.

12. The mechanical fluid pump as recited in claim 7, wherein the actuator is a vacuum actuator.
